(19) United States
(12) Patent Application Publication
(10) Pub. No.: US 2011/0295486 A1
(43) Pub. Date: Dec. 1, 2011

(54) Automated Anti-Idle Warning And Shutoff System And Method

(75) Inventors: Randall Lawrence Guensler, Atlanta, GA (US); Vetri Venthan Elango, Gainesville, FL (US); Philip Blaiklock, Atlanta, GA (US)

(73) Assignee: Georgia Tech Research Corporation, Atlanta, GA (US)

(21) Appl. No.: 13/149,656

(22) Filed: May 31, 2011

Related U.S. Application Data
(60) Provisional application No. 61/349,284, filed on May 28, 2010.

(51) Int. Cl. F02D 45/00

(52) U.S. Cl. 701/102

(57) ABSTRACT

Systems and methods for assessing engine idle condition, comparing current idle conditions to allowable conditions for specific roadway locations, warning drivers and others as to status of current engine idle conditions, and automatically shutting down the engine when idle thresholds are exceeded.

### CROSS-REFERENCE TO RELATED APPLICATIONS

This application claims the benefit of U.S. Provisional Application No. 61/349,284 filed 28 May 2010, the entire contents and substance of which are hereby incorporated by reference.

### BACKGROUND OF THE INVENTION

1. Field of the Invention

This invention relates generally to the field of emissions reduction, and more specifically to systems and methods for assessing engine idle condition, comparing current idle conditions to allowable conditions for specific geographic locations (e.g. roadway, parking, vehicle staging locations, etc.) warning drivers and others as to status of current engine idle conditions, and automatically shutting down the engine when idle thresholds are exceeded.

2. Description of Related Art

Emissions reductions that could be achieved from idle reduction technologies are potentially significant. More than 500,000 school buses operate nationwide, and most of these buses utilize diesel fuel. School buses typically are operated for more than six hours per day, making them a significant contributor to mobile source emissions. In Metropolitan Atlanta, there are many more school buses than public transit buses, and school buses have a larger impact on the regional emissions inventory.

Idling activity contributes as much as 30% of daily bus emissions. Exhaust fumes in bus zones directly expose children directly to particulate matter. Constant exposure to diesel fumes puts children at a greater risk of developing cancer, asthma, and other respiratory problems. With respect to vehicle idling and queuing, recent studies have found that the concentration of fine particulate matter in the cabins of buses operating with open windows can increases significantly (Hill, et al., 2005). Hence, controlling the amount of time school buses spend idling has significant health and economic benefits. When applied to school buses, anti-idle systems reduce the exposure of school children to pollutants, thereby protecting one of the most sensitive populations. Because exhaust can also leak into buildings adjacent bus idling zones, school employees, school neighbors, and parents also benefit from idle reduction.

Few studies have monitored the extent of excess idle in school bus fleets. However, some limited studies conducted in California and Oklahoma are noteworthy. A 1994 study for the California Air Resources Board (Horie, et al., 1994) determined that a large fraction of operating time was spent in idle (about 30% of daily trip duration) for both transit and school buses, with school buses conducted their idling in 21-23 daily idling events.

In a two-year study conducted in Oklahoma, the Association of Central Oklahoma Governments and Choctaw-Nicoma Park Public Schools conducted a study of school bus idling and the extent of fuel savings that could be achieved by limiting idling to five minutes (Anderson and Glencross, 2009). The Oklahoma study monitored 15 school buses on a variety of routes, and found that the buses idled for approximately 24 minutes per day after instituting anti-idle driver education strategies, compared to approximately 60 minutes of idling reported by bus drivers prior to instituting the program (Anderson and Glencross, 2009).

In addition, in a press release (USEPA, 2009), the EPA inferred that First Student Inc., a school bus transportation company operating in New England, was hoping to achieve a one hour per day reduction in excessive idling from their fleet as part of an enforcement settlement case on excessive idling.

Thus, it is evident that idle reduction technologies are beneficial in reducing emissions. It would be desirable to provide improved systems and methods for assessing engine idle condition, comparing current idle conditions to allowable conditions for specific roadway locations, warning drivers and others as to status of current engine idle conditions, and automatically shutting down the engine when idle thresholds are exceeded. It is to such systems and methods that that present invention is primarily directed.

### BRIEF SUMMARY OF THE INVENTION

Briefly described, in preferred form, the present invention is an automated anti-idle warning and shutoff system for a vehicle with an engine operating in an anti-idle zone comprising a vehicle sensing system that senses vehicle characteristics, a vehicle processor that records and processes the vehicle characteristics, a vehicle database storing idling parameters, an optional communications system to a remote server, a vehicle display, and a shut-off system responsive to the processing of the vehicle characteristics and the idling parameters, wherein the shut-off system can shut off the engine of the vehicle and that is triggered locally or remotely from a server by a communications system.

At least one of the vehicle characteristics can be a characteristic related to engine idling. At least one of the idling parameters can be a parameter related to an allowable idle time threshold for at least one roadway or other geographic element.

When the characteristic related to engine idling falls outside the parameter related to allowable idle time threshold for at least one roadway or geometric element, the vehicle display can display a warning that the shut-off system will shut off the engine of the vehicle in a pre-set time period.

During the pre-set time period, the shut-off system can be overridden so the shut-off system does not shut off the engine of the vehicle. If during the pre-set period, the shut-off system is not overridden, the shut-off system is designed to shut off the engine of the vehicle.

The at least one roadway or geographic element comprising the anti-idle zone can be defined by a unique polygon comprising latitude and longitude coordinates bounding an operating zone of the vehicle.

In another exemplary embodiment, the present invention comprises systems and methods for identifying when vehicles are idling excessively, warning that excessive idle is occurring, and automatically shutting off the engine when the duration of engine idle exceeds pre-programmed idle threshold values for specific locations. The present anti-idle system can be applicable to many types of on road and off-road vehicles and operations, including, but not limited to, light-duty vehicles, on road heavy-duty trucks, off-road heavy construction vehicles, locomotives, drayage engines, and non road engines.

In one example of the benefit of the present invention, with over 107,000 students, Cobb County School District (CCSD) is the second largest school district in Georgia and the 25^{th} largest in the United States. CCSD also deploys the 17^{th} largest school bus fleet in the nation with 1150 vehicles, due in part to the county's suburban nature.

Cobb County officials estimate that their school buses are currently idling as much as two hours per day, including start up operations at the beginning of the day and idling that occurs in staging areas and at stop locations. By installing the anti-idle system in this example bus fleet, engine idling may be reduced by more than 50%, with the following savings:

0.85 tons of particulate matter;

31.4 tons of oxides of nitrogen;

1099 tons of carbon dioxide; and

99,000 gallons of diesel fuel.

Using EPA's online Diesel Emissions Quantifier, the capital cost-effectiveness results for a fleet-wide idle reduction program of the present invention is estimated to be $106,000 per ton/year for particulate matter (PM), $2,900 per ton/year for nitrogen oxides (NOₓ) and, and $82 per ton/year for carbon dioxide (CO₂), indicating that diesel idle control provides PM reductions for a significantly lower cost than add-on control programs, and also provide cost-effective NOₓ reductions that help reduce ozone formation.

Plus, the idle control reductions occur fleet-wide and benefits accrue to all schools, as opposed to being implemented only on certain bus routes. If the present invention were to be applied to the entire fleet, CCSD estimates that they will save approximately $235,000 in fuel per year, which should be sufficient to pay for continuous operation of the automatic idle reduction systems.

Given other expected savings such as reduced maintenance, reduced crash damage from driver monitoring, etc., CCSD also expects to be able to save enough money to refresh the hardware every four years to take advantage of new technologies as they evolve. Hence, the present idle reduction program should actually pay for itself over a four-year cycle. On a dollar-per-dollar basis, idle reduction programs out-perform the use of add-on controls to achieve school bus fleet emissions reductions.

In further exemplary embodiments, the present invention comprises an automated anti-idle warning and shutoff system for a vehicle with an engine operating in an anti-idle zone comprising a vehicle sensing system that senses vehicle characteristics, a vehicle processor that records and processes the vehicle characteristics, a vehicle database storing idling parameters, an optional communications system to a remote server, a vehicle display, and a shut-off system responsive to the processing of the vehicle characteristics and the idling parameters, wherein the shut-off system can shut off the engine of the vehicle and that is triggered locally or remotely from a server by a communications system, wherein at least one of the vehicle characteristics is a characteristic related to engine idling, wherein at least one of the idling parameters is a parameter related to an allowable idle time threshold for at least one roadway or other geographic element, wherein when the characteristic related to engine idling falls outside the parameter related to allowable idle time threshold for at least one roadway or geometric element, the vehicle display displays a warning that the shut-off system will shut off the engine of the vehicle in a pre-set time period, wherein during the pre-set time period, the shut-off system can be overridden so the shut-off system does not shut off the engine of the vehicle, wherein, if during the pre-set period, the shut-off system is not overridden, the shut-off system shuts off the engine of the vehicle, and wherein the at least one roadway or geographic element comprising the anti-idle zone is defined by a unique polygon comprising latitude and longitude coordinates bounding an operating zone of the vehicle.

In further exemplary embodiments, the present invention comprises an automated anti-idle warning and shutoff system comprising an in-vehicle computer coupled to vehicle sensors that sense vehicle position, speed, and operating parameters, an in-vehicle database comprising vehicle characteristics, vehicle performance characteristics, driver demographics, route service characteristics, roadway and land use characteristics, roadway operating conditions, environmental conditions, and roadway elements that link vehicle position, software that runs on the in-vehicle computer that compares engine idle time to anti-idle conditions in real-time, derived from data in the database and the vehicle sensors, an in-vehicle display for displaying the idle status to the driver of the vehicle in real time, and an in-vehicle electrical circuit controlled by the in-vehicle computer that changes the state of an electrical or electromechanical device to shut off power to the engine when idle time exceeds anti-idle conditions.

The in-vehicle computer can communicate with a remote server that comprises a transportation system database that comprises roadway characteristics and roadway operating conditions, a demographic database comprising driver and passenger demographics, a revealed vehicle activity database that comprises vehicle activity data, an environmental database comprising environmental data, a database comprising the histories of vehicle operating parameters in space and time, and a processor for computing updated engine idle condition as a function of the data in the respective databases and for updating the idle shutoff status in the software that runs on the in-vehicle computer, wherein the transportation system database, the demographic database, the revealed vehicle activity database, and the environmental database are linked.

The display can present real-time feedback to the driver relating to vehicle and engine operating parameters that affect engine idle status.

The processor on the in-vehicle system can be configured to toggle an electric circuit in response to computed idle condition so as to change the state of an electric or electromechanical device and shut down the engine.

The roadway and geographic elements can comprise updatable polygon fields, comprising latitude/longitude coordinates bounding discrete transportation facilities, and store encoded data for each transportation roadway element.

The roadway and geographic elements can comprise updatable location elements that store encoded data for each roadway element that are linked to vehicle position.

Roadway design parameters, operating parameters, and driver and passenger demographics can be remotely updatable from the remote server.

The remote server can be in communication with a driver/fleet computer to permit review of previous trips and planned future trips to minimize risk of violating idle shutoff conditions.

The processor on the remote server can be configured to automate data processing and management and automate statistical analysis in response to changes in received data.

The processor on the remote server can send a signal to the in-vehicle system in response to computed idle condition to toggle an electric circuit so as to change the state of an electric or electromechanical device and shut down the engine.

The processor on the remote server can configured to create reports identifying the effect of roadway element design and operating parameters at risk of violating idle control conditions, for use in improving roadway characteristics and roadway operating conditions.

In further exemplary embodiments, the present invention comprises a real-time idle condition evaluation method for use in a vehicle comprising storing, in the vehicle, vehicle characteristics and vehicle performance characteristics, driver and passenger demographics, roadway characteristics and roadway operating conditions, environmental conditions, and roadway elements that link vehicle position, sensing, in the vehicle, vehicle position, speed, and operating parameters; receiving, in the vehicle, prevailing roadway speeds and environmental conditions, computing, in the vehicle, using predetermined idle functions, derived from the sensed vehicle speed and position, received roadway speeds and environmental conditions, and the stored data, and changing the state of an electrical or electromechanical device in response to the computed idle condition so as to shut the engine off; and displaying the computed idle status to the driver of the vehicle in real time.

The method can further comprise communicating with a remote server, accessing roadway characteristics and roadway operating conditions, driver and passenger demographics, vehicle activity data, environmental data, and spatially resolved idle history data, all of which are linked, computing updated idle condition as a function of the accessed data, and updating the idle condition functions on the in-vehicle computer for use in computing the idle condition.

The method can further comprise remotely updating roadway design parameters, roadway operating parameters, and anti-idle policies for the applicable geographic area from the remote server.

The method can further comprise communicating between the remote server to a driver and/or fleet operator computer to permit review previous trips and planned future trips to minimize idle activity related to the future trips.

The method can further comprise automating data processing, management, and statistical analysis in the remote server in response to changes in received data.

The method can further comprise the activation of the electric circuit in response to the computed idle condition so as to change the state of an electric or electromechanical device to shut down the engine.

The method can further comprise creating reports on the remote server to identifying the effect of roadway element design and operating parameters on risk of violating idle shutoff conditions, for use in improving roadway design parameters and roadway operating conditions.

Displaying real-time feedback to the driver can relate to idle operations.

The roadway and geographic elements can comprise updatable polygon fields, comprising latitude/longitude coordinates bounding discrete transportation facilities, and store encoded data for each roadway element (e.g. roadway links, intersections, alleyways, driveways, parking lots, maintenance yards, or any other location that a vehicle may traverse).

The roadway and geographic elements can comprise updatable location elements that store encoded data for each roadway element that are linked to vehicle position.

These and other objects, features and advantages of the present invention will become more apparent upon reading the following specification in conjunction with the accompanying drawing figures.

### BRIEF DESCRIPTION OF THE DRAWINGS

Various features and advantages of the present invention may be more readily understood with reference to the following detailed description taken in conjunction with the accompanying drawings, wherein like reference numerals designate like structural elements, and in which:

FIG. 1 is a schematic of the present automated anti-idle warning and shutoff system hardware according to a preferred embodiment.

FIG. 2 is a schematic of the present automated anti-idle warning and shutoff system infrastructure according to a preferred embodiment.

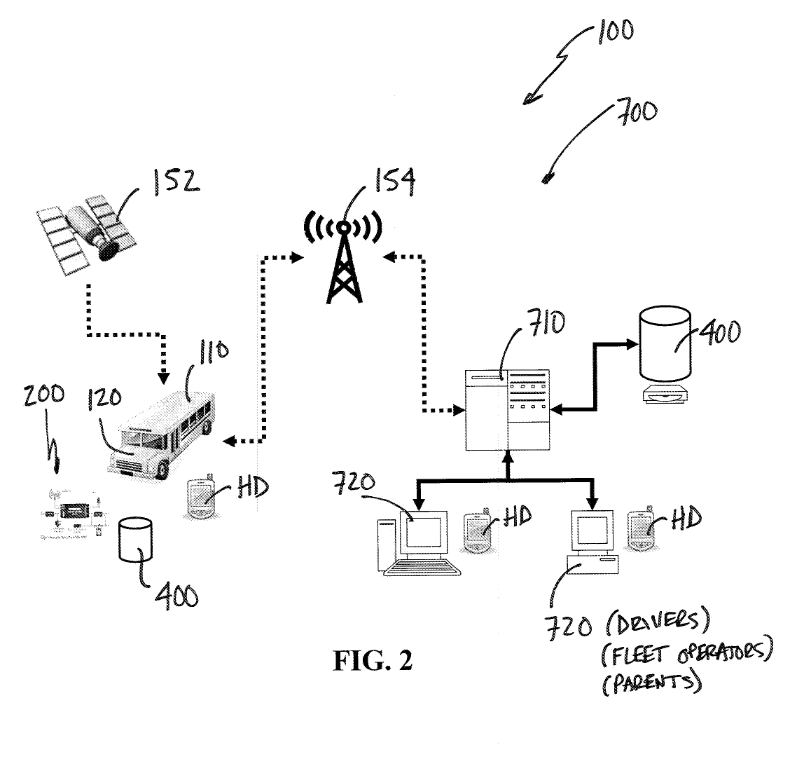

FIG. 3 illustrates an example of monitored roadway elements, links and intersections, according to a preferred embodiment of the present invention.

FIG. 4 illustrates an example of anti-idle zones for a bus yard and a school, according to a preferred embodiment of the present invention.

FIG. 5 illustrates an example of anti-idle zones for a school, with bus drop-off locations, according to a preferred embodiment of the present invention.

### DETAILED DESCRIPTION OF THE INVENTION

To facilitate an understanding of the principles and features of the various embodiments of the invention, various illustrative embodiments are explained below. Although exemplary embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” one particular value and/or to “about” or “approximately” another particular value. When such a range is expressed, other exemplary embodiments include from the one particular value and/or to the other particular value.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

As shown in the figures, the present automated anti-idle warning and shutoff system 100 for a vehicle 110 with an engine 120 operable in an operating zone Z comprises an in-vehicle system 200 and an infrastructure system 700. The in-vehicle system 200 comprises a vehicle sensing system 300 that senses vehicle characteristics, a vehicle database 400 storing idling parameters, a vehicle display 500; and a shut-off system 600 responsive to the processing of the vehicle characteristics and the idling parameters, wherein the shut-off system can shut off the engine 120 of the vehicle 110.

The present automated anti-idle warning and shutoff systems and methods can monitor engine idle state, compare the time at idle within the current operating zone to pre-set idle conditions, warn the driver and fleet operator when excessive idling occurs, and change the state of an electrical or electromechanical device to shut off the engine when a location-specific idle threshold is exceeded.

As shown in the figures, the present automated anti-idle warning and shutoff system 100 for a vehicle 110 with an engine 120 operable in an operating zone Z comprises an in-vehicle system 200 and an infrastructure system 700. The in-vehicle system 200 comprises a vehicle sensing system 300 that senses vehicle characteristics V_{C}, a vehicle database 400 storing idling parameters I_{P}, a vehicle display 500; and a shut-off system 600 responsive to the processing of the vehicle characteristics V_{C} and the idling parameters I_{P}, wherein the shut-off system can shut off the engine 120 of the vehicle 110.

In an exemplary embodiment, at least one of the vehicle characteristics V_{C} is a characteristic related to engine idling V_{CI}, at least one of the idling parameters I_{P} is a parameter related to an allowable idle time threshold I_{ITT} for at least one roadway element 800, wherein when the characteristic related to engine idling V_{CI} falls outside the parameter related to allowable idle time threshold I_{ITT} for at least one roadway or geometric element 800, the vehicle display 500 displays a warning that the shut-off system 600 will shut off the engine 120 of the vehicle 110 in a pre-set time period T_{P}, wherein during the pre-set time period T_{P}, the shut-off system 600 can be overridden so the shut-off system 600 does not shut off the engine 120 of the vehicle 110, wherein, if during the pre-set period T_{P}, the shut-off system 600 is not overridden, the shut-off system 600 shuts off the engine 120 of the vehicle 110, and wherein the at least one roadway or geometric element 800 is defined by a unique polygon comprising latitude and longitude coordinates bounding the operating zone Z of the vehicle 110.

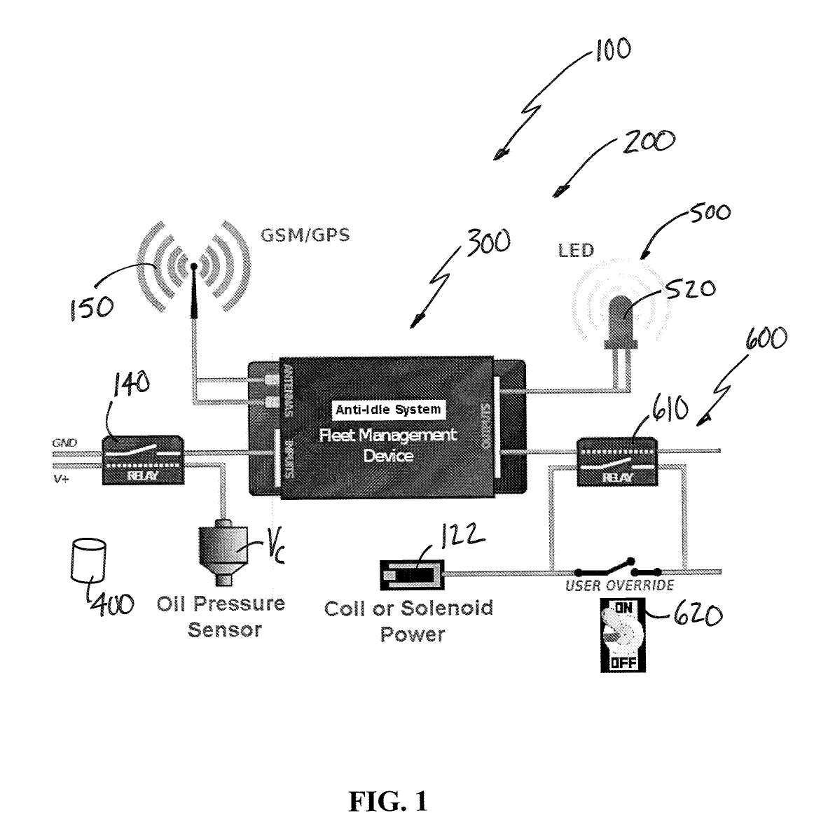

As shown in FIG. 1, the in-vehicle system 200 can comprise a vehicle sensing system 300 that senses vehicle characteristics, and in a preferred embodiment, comprises a vehicle telematics platform 310, including an onboard computer or similar processor capable of acting either independently or acting in concert with a remote server system. Vehicle characteristics V_{c} can comprise one or more of vehicle position, vehicle speed, vehicle acceleration, vehicle deceleration, and engine and other operating characteristics.

The in-vehicle system 200 can further comprise a vehicle database 400 storing idling parameters I_{P}, although one or more of these database(es) 400 can be remote from the vehicle 110. Idling parameters I_{P} can include, for example, vehicle performance characteristics, driver demographics, route service characteristics, roadway and land use characteristics, roadway operating conditions, environmental conditions, and roadway elements that link vehicle position.

The in-vehicle system 200 can further comprise a vehicle display 500 for displaying the idle status to the driver of the vehicle 120, preferably in real time. The vehicle display 500 can further comprise an idle warning system 510, such as a light-emitting diode warning light 520.

The in-vehicle system 200 can further comprise a shut-off system 600 responsive to the processing of the vehicle characteristics and the idling parameters, wherein the shut-off system can shut off the engine 120 of the vehicle 110. The shut-off system 600 can comprise timed relays 610 that change the state of an electrical or electromechanical device to shut off the engine 120.

The in-vehicle system 200 includes embedded position monitoring systems and communication hardware systems in the onboard telematics device 310 to provide real-time or delayed reporting of vehicle location, vehicle speed, and engine activity to the driver and fleet operator via a link 130, for example, communications antenna 132.

Engine idling is defined herein as continuous operation of the engine 120 while the vehicle 110 is stationary. Engine activity is monitored by the vehicle sensing system 300, which can, for example, continuously track oil pressure or other vehicle characteristics V_{C} to determine when the engine is running (as opposed to the key-on, engine-off condition). When the engine 120 is running, a relay 140 can be triggered, and the state of engine operation recorded on the monitoring system 310. Vehicle 110 motion can be monitored by continuously tracking vehicle position via global positioning 150/152, cell tower location monitoring data 154, or other location sensing and reporting systems embedded in or communicating with the onboard device 310, or by monitoring acceleration rates via accelerometers or other sensing systems embedded in or connected to the onboard device 310. Idling is quantified when the vehicle 110 remains stationary for an extended period.

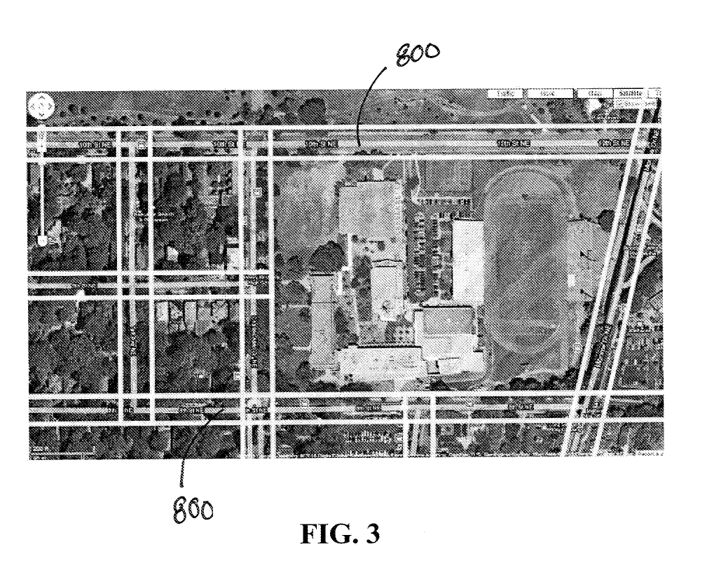

The driver or fleet operator can establish allowable idle time thresholds I_{ITT} for roadway elements 800 or groups of elements (FIG. 3), i.e. the operating zone Z of the vehicle 110. Roadway or geometric elements 800 can include roadway links, intersections, alleyways, driveways, parking lots, maintenance yards, and other surfaces and locations that the vehicle 110 may traverse.

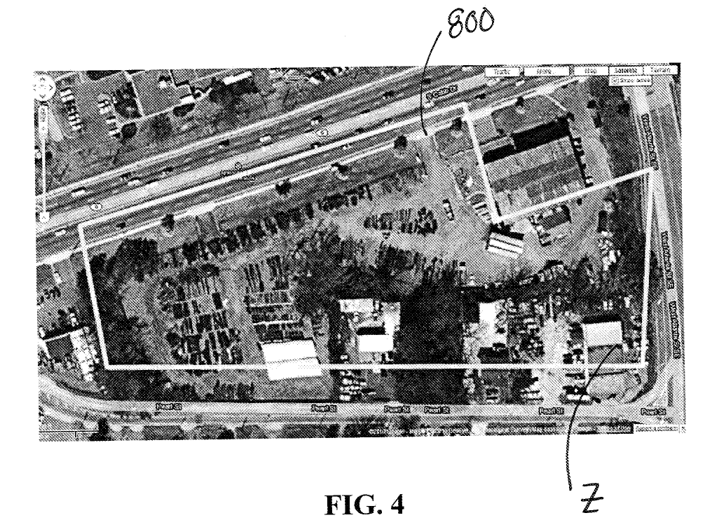

In an exemplary embodiment, each roadway element 800 (FIGS. 3 and 4) is defined as a unique polygon comprising latitude/longitude coordinates bounding the operating zone Z of the vehicle 110, and linked in one or more databases 400 with encoded facility data for each roadway element 800, and idling parameters I_{P}, for example, roadway operating conditions and local land use characteristics.

The encoded data for each roadway element 800 can include such factors as facility type, number of lanes, grade, curvature, and speed limit. The various databases 400 can operate remotely on a server 710 of the infrastructure system 700, or can be operated by the in-vehicle system 200 and updated via the communications network 700 to the mobile system 200.

The remote server and mobile database systems 400 can contain detailed information associated with participating companies (e.g. company name, industry classification, address, contact information, etc.), driver demographics, vehicle and vehicle characteristics (model year, engine family, emissions control systems, etc.), vehicle performance characteristics (e.g., engine power, transmission, acceleration rates, etc.), engine operating parameters, route stops and service characteristics, and environmental conditions. The remote and mobile database systems 400 can contain real-time data related to on road operations, including but not limited, to roadway operating conditions (e.g., prevailing vehicle speeds, congestion conditions, construction events, etc.) and environmental conditions (temperature, humidity, rainfall rates, snow rates, light levels, etc.). These data are updated via telecommunications links 130.

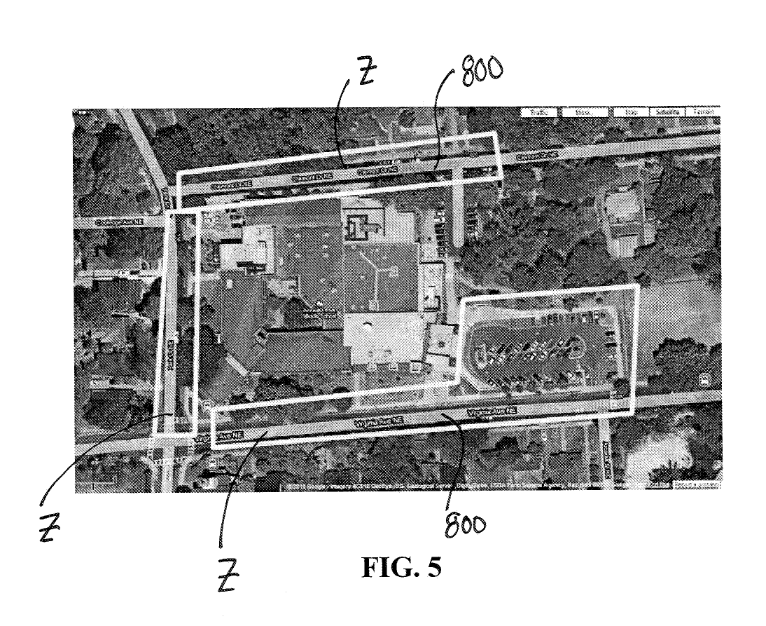

In implementing anti-idle operating zone Z, the fleet operator can establish a roadway element 800 or zone encompassing, for example, a maintenance yard and set, for example, a six-minute allowable idle threshold for that element. (FIG. 4). School bus operators may similarly establish, for example, four-minute allowable idle time limits at, for example, school bus stops, schools, and bus staging areas. (FIG. 5). Whenever a vehicle is operating within an anti-idle operating zone Z, the duration of vehicle idling is actively monitored by the onboard system 310.

The present invention continuously or intermittently tracks vehicle position using, for example, global positioning systems, cellular tower tracking, or similar functions. To continuously track roadway or geometric element locations, the system compares current global positioning data to the roadway element polygon data contained in the onboard device 310 software system or in the remote server system 710. The system identifies the specific roadway upon which the vehicle is operating (FIG. 3) and determines whether the vehicle is operating in an anti-idle operating zone Z (FIGS. 4 and 5). When the software algorithms determine that the vehicle is operating within one of the anti-idle operating zones Z, and when the onboard vehicle system 310 determines that the vehicle stops moving while the engine remains running, the onboard vehicle system and/or remote system idle timer begins tracking idle duration.

The systems continuously compare the idle timer value to the pre-established idle threshold value for the zone in which the vehicle is operating. When idle time exceeds the primary threshold level for the roadway element, the onboard device and/or remote server can automatically trigger the illumination of a warning light 520 or some other in-vehicle warning system (e.g., horn, chime, etc.) and send the driver and/or fleet operator a message (e.g. a text message, e-mail, or similar notification) to their handheld devices HD.

The message alerts both parties that the engine will be automatically shut down within a pre-set period for that roadway element or zone (e.g. five minutes). If there is a reason to keep the engine on while the bus is stationary (e.g. special needs, safety, cold weather, etc., for example see Georgia Department of Education bus idling guidelines, Guidelines for the Elimination of Unnecessary School Bus Idling, Jan. 30, 2009. Georgia Department of Education: Pupil Transportation. Mar. 7, 2009. http://public.doe.k12.ga.us/), the driver or fleet operator can respond to the message and reset the server idle timer as warranted. When idle time exceeds a secondary threshold level, the system can trigger an electrical circuit relay 610 that shuts down the engine. Because the relay 610 operates on a timer, the engine can be immediately restarted if desired.

In gasoline-powered vehicles, engine shutdown is typically handled by cutting power to the coil 122 and eliminating the delivery of spark to the combustion chamber. However, engine shutdown in gasoline engines may also be handled by other electrical or electromechanical means. In diesel engines, engine shutdown is typically handled by cutting power to the diesel fuel-shutoff solenoid 122, eliminating delivery of fuel to the combustion chamber. However, diesel engine shutdown may also be handled by other electrical or electromechanical means. Depending upon system configuration, the onboard control relays can be managed directly by programs running on the onboard software systems 310 or can be managed by programs running on the remote server system 710 which can then send a signal to the onboard device to trigger the relay remotely.

The system can further comprise a bypass circuit 124 allowing the driver and/or fleet operator to override the relay, ensuring the system will not shut down the engine under conditions when the engine needs to remain in operation for an extended period (e.g., when mechanics are performing maintenance on the system that requires extended idling or under any conditions where automatic engine shutdown could cause a safety hazard).

Daily idle reports for each vehicle and summary reports for subfleets are automatically generated by the remote server 710 and dispersed to drivers and fleet operators via the Internet and handheld applications HD. This feedback mechanism allows drivers to compare their performance to the performance of other drivers and allows the fleet operator to use the data in driver competitions and efficiency evaluations. Drivers and operators can use the data to identify areas where idling restrictions are most frequently violated and for use in identifying new anti-idle zones that should be established. Because all actions are tracked on the server 710, including responses to idle warnings, fleet managers can assess system effectiveness route by route, subfleet, geographic region, etc.

The system allows third parties to also access data remotely if desired. For example, in a bus application, parents can log into the system via an Internet 720 or wireless connection HD to access related data.

While the invention has been disclosed in its exemplary forms, it will be apparent to those skilled in the art that many modifications, additions, and deletions can be made therein without departing from the spirit and scope of the invention and its equivalents, as set forth in the following claims.

We claim:

1. An automated anti-idle warning and shutoff system for a vehicle with an engine operable in an operative zone comprising:
a vehicle sensing system that senses vehicle characteristics;
a vehicle database storing idling parameters;
a vehicle display; and
a shut-off system responsive to the processing of the vehicle characteristics and the idling parameters, wherein the shut-off system can shut off the engine of the vehicle;
wherein at least one of the vehicle characteristics is a characteristic related to engine idling;
wherein at least one of the idling parameters is a parameter related to an allowable idle time threshold for at least one roadway element;
wherein when the characteristic related to engine idling falls outside the parameter related to allowable idle time threshold for at least one roadway element, the vehicle display displays a warning that the shut-off system will shut off the engine of the vehicle in a pre-set time period;
wherein during the pre-set time period, the shut-off system can be overridden so the shut-off system does not shut off the engine of the vehicle; and
wherein, if during the pre-set period, the shut-off system is not overridden, the shut-off system shuts off the engine of the vehicle.

2. The automated anti-idle warning and shutoff system of claim 1, further comprising defining the at least one roadway element by a unique polygon comprising latitude and longitude coordinates bounding an operating zone of the vehicle.

3. The automated anti-idle warning and shutoff system of claim 1, wherein vehicle characteristics further comprise one or more of vehicle position, vehicle speed, vehicle acceleration, vehicle deceleration, and engine operating characteristics.

4. The automated anti-idle warning and shutoff system of claim 1, wherein idling parameters further comprise one or more of vehicle performance parameters, driver demographics, route service characteristics, roadway and land use characteristics, roadway operating conditions, and environmental conditions.

5. An automated anti-idle warning and shutoff system for a vehicle with an engine operating in an anti-idle zone comprising:
a vehicle sensing system that senses vehicle characteristics;
a vehicle processor that records and processes the vehicle characteristics;
a vehicle database storing idling parameters;
an optional communications system to a remote server;
a vehicle display; and
a shut-off system responsive to the processing of the vehicle characteristics and the idling parameters, wherein the shut-off system can shut off the engine of the vehicle and that is triggered locally or remotely from a server by a communications system;
wherein at least one of the vehicle characteristics is a characteristic related to engine idling;
wherein at least one of the idling parameters is a parameter related to an allowable idle time threshold for at least one roadway or other geographic element;
wherein when the characteristic related to engine idling falls outside the parameter related to allowable idle time threshold for at least one roadway or geometric element, the vehicle display displays a warning that the shut-off system will shut off the engine of the vehicle in a pre-set time period;
wherein during the pre-set time period, the shut-off system can be overridden so the shut-off system does not shut off the engine of the vehicle;
wherein, if during the pre-set period, the shut-off system is not overridden, the shut-off system shuts off the engine of the vehicle; and
wherein the at least one roadway or geographic element comprising the anti-idle zone is defined by a unique polygon comprising latitude and longitude coordinates bounding an operating zone of the vehicle.

6. An automated anti-idle warning and shutoff system comprising:
an in-vehicle computer coupled to vehicle sensors that sense vehicle position, speed, and operating parameters;
an in-vehicle database comprising vehicle characteristics, vehicle performance characteristics, driver demographics, route service characteristics, roadway and land use characteristics, roadway operating conditions, environmental conditions, and roadway elements that link vehicle position;
software that runs on the in-vehicle computer that compares engine idle time to anti-idle conditions in real-time, derived from data in the database and the vehicle sensors;
an in-vehicle display for displaying the idle status to the driver of the vehicle in real time; and
an in-vehicle electrical circuit controlled by the in-vehicle computer that changes the state of an electrical or electromechanical device to shut off power to the engine when idle time exceeds anti-idle conditions.

7. The automated anti-idle warning and shutoff system of claim 6, wherein the in-vehicle computer communicates with a remote server that comprises:
a transportation system database that comprises roadway characteristics and roadway operating conditions;
a demographic database comprising driver and passenger demographics;
a revealed vehicle activity database that comprises vehicle activity data;
an environmental database comprising environmental data;
a database comprising the histories of vehicle operating parameters in space and time; and
a processor for computing updated engine idle condition as a function of the data in the respective databases and for updating the idle shutoff status in the software that runs on the in-vehicle computer;
wherein the transportation system database, the demographic database, the revealed vehicle activity database, and the environmental database are linked.

8. The automated anti-idle warning and shutoff system of claim 6, wherein the display presents real-time feedback to the driver relating to vehicle and engine operating parameters that affect engine idle status.

9. The automated anti-idle warning and shutoff system of claim 6, wherein the processor on the in-vehicle system is configured to toggle an electric circuit in response to computed idle condition so as to change the state of an electric or electromechanical device and shut down the engine.

10. The automated anti-idle warning and shutoff system of claim 6, wherein the roadway elements comprise updatable polygon fields, comprising latitude/longitude coordinates bounding discrete transportation facilities, and store encoded data for each transportation roadway element.

11. The automated anti-idle warning and shutoff system of claim 6, wherein the roadway elements comprise updatable location elements that store encoded data for each roadway element that are linked to vehicle position.

12. The automated anti-idle warning and shutoff system of claim 7, wherein roadway design parameters, operating parameters, and driver and passenger demographics are remotely updatable from the remote server.

13. The automated anti-idle warning and shutoff system of claim 7, wherein the remote server is in communication with a driver/fleet computer to permit review of previous trips and planned future trips to minimize risk of violating idle shutoff conditions.

14. The automated anti-idle warning and shutoff system of claim 7, wherein the processor on the remote server is configured to automate data processing and management and automate statistical analysis in response to changes in received data.

15. The automated anti-idle warning and shutoff system of claim 7, wherein the processor on the remote server sends a signal to the in-vehicle system in response to computed idle condition to toggle an electric circuit so as to change the state of an electric or electromechanical device and shut down the engine.

16. The automated anti-idle warning and shutoff system of claim 7, wherein the processor on the remote server is configured to create reports identifying the effect of roadway element design and operating parameters at risk of violating idle control conditions, for use in improving roadway characteristics and roadway operating conditions.

17. A real-time idle condition evaluation method for use in a vehicle comprising:
storing, in the vehicle, vehicle characteristics and vehicle performance characteristics, driver and passenger demographics, roadway characteristics and roadway operating conditions, environmental conditions, and roadway elements that link vehicle position;
sensing, in the vehicle, vehicle position, speed, and operating parameters; receiving, in the vehicle, prevailing roadway speeds and environmental conditions;
computing, in the vehicle, using predetermined idle functions, derived from the sensed vehicle speed and position, received roadway speeds and environmental conditions, and the stored data;
changing the state of an electrical or electromechanical device in response to the computed idle condition so as to shut the engine off; and
displaying the computed idle status to the driver of the vehicle in real time.

18. The method of claim 17 further comprising:
communicating with a remote server;
accessing roadway characteristics and roadway operating conditions, driver and passenger demographics, vehicle activity data, environmental data, and spatially resolved idle history data, all of which are linked;
computing updated idle condition as a function of the accessed data; and
updating the idle condition functions on the in-vehicle computer for use in computing the idle condition.

19. The method of claim 18, wherein displaying real-time feedback to the driver relates to idle operations.

20. The method of claim 18 further comprising remotely updating roadway design parameters, roadway operating parameters, and anti-idle policies for the applicable geographic area from the remote server.
